(19) United States
(12) Patent Application Publication
(10) Pub. No.: US 2023/0113491 A1
(43) Pub. Date: Apr. 13, 2023

(54) DISPUTED CLAIM IDENTIFICATION IN ELECTRONIC CONTENT ITEMS

(71) Applicant: Primer Technologies, Inc., San Francisco, CA (US)

(72) Inventors: Gregory P. Finley, Berkeley, CA (US); John N. Bohannon, San Francisco, CA (US); Vedant Dharnidharka, Fremont, CA (US); Nicholas R. Egan, San Francisco, CA (US)

(21) Appl. No.: 17/963,356

(22) Filed: Oct. 11, 2022

Related U.S. Application Data
(60) Provisional application No. 63/253,611, filed on Oct. 8, 2021.

(51) Int. Cl. G06F 40/40

(52) U.S. Cl. CPC G06F 40/40; G06Q 50/01

(57) ABSTRACT

The technology disclosed herein identifies claims made in electronic content items that are disputed. In a particular implementation, a method provides extracting first claims from language in a set of electronic content items and determining that a disputed claim of the first claims is disputed by one or more disputing entities. The method further includes storing claim information about the disputed claim in a repository. The claim information indicates the disputed claim, one or more supporting entities that support the disputed claim, and the disputing entities. The method also includes receiving analysis parameters from a user, wherein the claim information satisfies the analysis parameters. In response to receiving the analysis parameters, the method includes presenting at least a portion of the claim information to the user.

### RELATED APPLICATIONS

This application is related to and claims priority to U.S. Provisional Patent Application 63/253,611, titled “DISPUTED CLAIM IDENTIFICATION IN ELECTRONIC CONTENT ITEMS,” filed Oct. 8, 2021, and which is hereby incorporated by reference in its entirety.

### TECHNICAL BACKGROUND

Given the seemingly limitless amount of information available over the Internet, claims being made in electronic content items (e.g., news articles, blog posts, social media posts, videos, podcasts, etc.) can be difficult, if not impossible, to sort through. If a claim is made in a content item, then it is possible that a person consuming that content item will have no idea whether the claim is disputed in another content item. The person may, therefore, never become aware of the claim's disputed nature. Likewise, considering the number of claims being made across hundreds, thousands, or even millions, of content items, the prevalence of disputed claims may be difficult to determine and analyze.

### OVERVIEW

The technology disclosed herein identifies claims made in electronic content items that are disputed. In a particular implementation, a method provides extracting first claims from language in a set of electronic content items and determining that a disputed claim of the first claims is disputed by one or more disputing entities. The method further includes storing claim information about the disputed claim in a repository. The claim information indicates the disputed claim, one or more supporting entities that support the disputed claim, and the disputing entities. The method also includes receiving analysis parameters from a user, wherein the claim information satisfies the analysis parameters. In response to receiving the analysis parameters, the method includes presenting at least a portion of the claim information to the user.

In some examples, the method includes retrieving the set of electronic content items over a communication network from one or more content item repositories.

In some examples, the method includes iteratively retrieving a first portion of the set of electronic content items that are new since a previous retrieval of a second portion of the set of electronic content items.

In some examples, the method includes, in response to identifying a first instance of the disputed claim in a first content item, creating a record for the disputed claim in the repository. The record includes the claim information. In response to identifying a second instance of the disputed claim in a second content time, the method includes updating the record based on the second instance. The second instance may phrase the disputed claim differently than the first instance.

In some examples, extracting the first claims includes passing the set of electronic content items through a Natural Language Processing (NLP) algorithm trained to recognize language used when making a claim.

In some examples, determining that a disputed claim of the first claims is disputed by one or more disputing entities includes determining that facts about an event in the disputed claim differ from facts about the event in one or more other claims of the first claims.

In some examples, the analysis parameters comprise a Boolean search query.

In some examples, the set of electronic content items includes one or more of media types including news articles, blog posts, social media posts, videos, and podcasts.

In some examples, the computing system comprises a user device of the user.

In another example, an apparatus includes one or more computer readable storage media and a processing system operatively coupled with the one or more computer readable storage media. Program instructions stored on the one or more computer readable storage media that, when read and executed by the processing system, direct the apparatus to extract first claims from language in a set of electronic content items and determine that a disputed claim of the first claims is disputed by one or more disputing entities. The program instructions further direct the apparatus to store claim information about the disputed claim in a repository. The claim information indicates the disputed claim, one or more supporting entities that support the disputed claim, and the disputing entities. The program instructions also direct the apparatus to receive analysis parameters from a user. The claim information satisfies the analysis parameters. In response to receiving the analysis parameters, the program instructions direct the apparatus to present at least a portion of the claim information to the user.

### BRIEF DESCRIPTION OF THE DRAWINGS

FIG. 1 illustrates an implementation for identifying disputed claims in electronic content items.

FIG. 2 illustrates an operation to identify disputed claims in electronic content items.

FIG. 3 illustrates an implementation for identifying disputed claims in electronic content items.

FIG. 4 illustrates an operational scenario for identifying disputed claims in electronic content items.

FIG. 5 illustrates an operational scenario for identifying disputed claims in electronic content items.

FIG. 6 illustrates an operational scenario for identifying disputed claims in electronic content items.

FIG. 7 illustrates an operational scenario for identifying disputed claims in electronic content items.

FIG. 8 illustrates a computing architecture for identifying disputed claims in electronic content items.

### DETAILED DESCRIPTION

The disputed claims service herein retrieves electronic content items from content item repositories and extracts information about whether claims made in those content items are disputed. In some cases, the same content item that makes a claim also notes that the claim is disputed while, in other cases, the claim may be disputed in another content item. In addition to determining that a claim is disputed, the disputed claims service may also determine an entity (e.g., person, publication, corporation, government, etc.), or entities, making (or supporting) the claim and/or an entity, or entities that are disputing the claim (e.g., denying the truthfulness of the claim either as a whole or in part). By aggregating disputed claim information across large numbers of content items and content item sources, the disputed claims service can identify items of interest for a user based on query parameters provided by the user. For example, if the user provides an entity and a timeframe, then the disputed claims service may responsively provide the user with all disputed claims made by the entity during the time frame in accordance with what the disputed claims service found in the analyzed content items. Especially given that, even today, most electronic content items do not include disputed claims, sorting through large numbers (i.e., millions plus) of content items to identify disputed claims therein would be impossible for a human user.

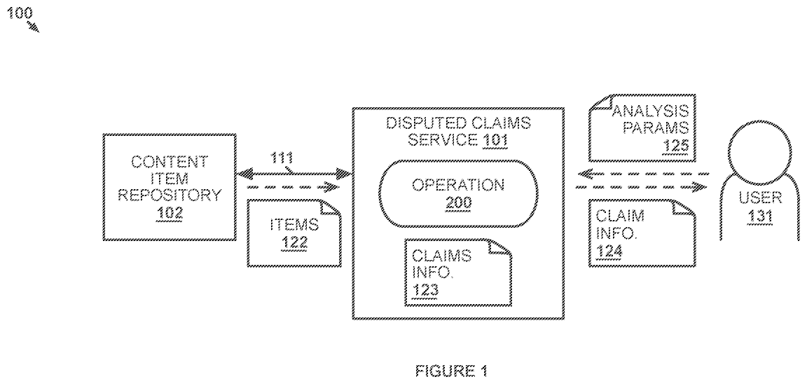

FIG. 1 illustrates implementation 100 for identifying disputed claims in electronic content items. Implementation 100 includes disputed claims service 101 and content item repository 102. Disputed claims service 101 may be a user device interacting with user 131 directly (e.g., personal computer, tablet, smartphone, information kiosk, advertisement display, etc.), may be a system in connection with a user device operated by user 131 (e.g., a server, such as a web server that provides a disputed claims web application, connected to a user device of user 131 over a communication network), or may be some combination thereof.

In operation, disputed claims service 101 retrieves content items 122 from content item repository 102 to identify disputed claims therein. Content items 122 may be news articles, blog posts, social media posts, videos, audio, podcasts, or some other type of media that conveys information to a user. Content item repository 102 communicates with disputed claims service 101 over communication link 111, which may be a direct link, wired and/or wireless, or may include intervening networks, systems, and/or devices. Content item repository 102 comprises one or more computer readable storage media, such as a hard disk drive, flash storage, or other type of data storage media. Content item repository 102 may further include processing and communication circuitry necessary to manage data storage and exchanged data over communication link 111. Content item repository 102 may be a web server (e.g., providing a website), electronic message board server, social network server, media server, or some other type of computing system capable of providing content items 122 over communication link 111. While this example includes only one repository, content item repository 102 may be one or multiple repositories from which content items 122 are retrieved by disputed claims service 101. For example, content item repository 102 may be a web server for a website of one news organization and another content item repository may be a web server for a website of another news organization.

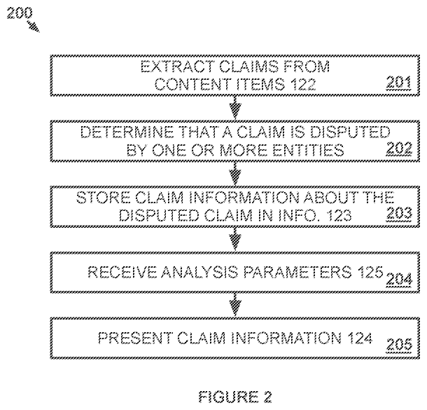

FIG. 2 illustrates operation 200 to identify disputed claims in electronic content items. In operation 200, disputed claims service 101 extracts claims made within content items 122 (201). To obtain content items 122 for processing to identify the claims, disputed claims service 101 may request all content items from content item repository 102 in a single request or content items 122 may be retrieved from content item repository 102 in an iterative approach. For example, disputed claims service 101 may periodically scrape content item repository 102 for content items that were not included in a previous scrape of content items or content item repository 102 may be configured (e.g., through a user account associated with disputed claims service 101) to automatically push new content items to disputed claims service 101. In some cases, disputed claims service 101 may only be concerned with content items of a given age and disputed claims service 101 may, therefore, request content items 122 as being content items in that age range (e.g., content items in the past five years).

Disputed claims service 101 may identify the claims from within content items 122 by passing each of content items 122 through a natural language processing (NLP) algorithm trained to recognize language making a claim (e.g., that an event happened and details regarding that event). If a content item is not natively text (e.g., a web article or text post), then the content item may be converted to text prior to being passed to the NLP algorithm. For example, words spoken in audio of the content item may be converted to text using a speech-to-text algorithm. Disputed claims service 101 may determine that a same claim is presented in more than one of content items 122 or repeated multiple times in one of content items 122. In those cases, disputed claims service 101 may deduplicate the multiple instances of the one claim and categorize the multiple instances as a single claim. The resulting deduplicated claim may use wording derived from a first instance of the claim that was found by disputed claims service 101, use a new phrasing of the claim generated by disputed claims service 101 (e.g., using a terminology rule set), or the claim may be represented in some other manner.

An entity making the claim is also identified by disputed claims service 101 along with the claim itself. In some examples, the NLP algorithm, or another algorithm, may be trained and used to identify claim attribution in the language presenting the claim. For instance, the language in the content item may explicitly state an entity that is making the claim. In some cases, a claim may be made in a quote and the speaker attributed with making that quote may be the entity making the claim. A person making the claim may also be representing another person or other type of entity (e.g., a public relations representative for a company). Disputed claims service 101 may then attribute the claim to the entity being represented rather than the person from which the quote originated. Similarly, disputed claims service 101 may attribute the claim to the same entity under different designations (e.g., one content item may attribute a claim to the president while another uses the president's name). In some cases, if no specific entity making the claim is found in the content item (either explicitly or implicitly), the author of the content item or publication of the content item may be attributed as making the claim.

Disputed claims service 101 also determines at least one claim from content items 122 that is disputed by one or more disputing entities (202). A subject claim may be disputed when disputed claims service 101 determines that another claim indicates that at least a portion of the claim is not true (e.g., the denial of the subject claim may be considered a claim in and of itself) or a claim denial may be recognized as such and disputed claims service 101 may not include that denial in the claims extracted from content items 122. The subject claim and the claim that disputes that subject claim may be identified in the same content item (e.g., a news article may present the subject claim and then note that a different entity disputes that subject claim). In one example, the other claim may explicitly deny that the subject claim is not true. For example, the subject claim may state that a person committed a crime, and the other claim may deny that the person committed the crime. In another example, the subject claim may be disputed implicitly. For instance, the subject claim may set forth a particular sequence of occurrences while another claim may set forth a different sequence of occurrences regarding the same event. Even if the other claim does not explicitly deny the sequence of the subject claim, the other claim implicitly disputes the subject claim by presenting different facts. Disputed claims service 101 would consider the subject claim to be disputed based on the differing sequences of events.

In examples where a different claim disputes the subject claim, the one or more entities making that claim, as determined in the discussion above, disputed claims service 101 can just use the determined entities as being the disputing entities. Although, in other examples, disputed claims service 101 may use similar processes (e.g., the NLP algorithm trained for claim attribution) to determine which entities are disputing the subject claim.

After identifying that a subject claim is disputed and is, therefore, a disputed claim, disputed claims service 101 stores information about the disputed claim in claims information 123 (203). Claims information 123 is stored in a storage repository for data on a storage medium local to disputed claims service 101 or otherwise accessible to disputed claims service 101 over a network. Claims information 123 includes information regarding disputed claims identified by disputed claims service 101 in the manner discussed above. For each disputed claim, claims information 123 indicates the disputed claim itself (e.g., verbatim from one of the content items or rephrased by disputed claims service 101), the one or more supporting entities that support the claim, and one or more disputing entities that dispute the claim. Claims information 123 may further indicate the content item(s) of content items 122 from where the disputed claim was made, the content item(s) of content items 122 from where it was determined that the disputed claim was disputed, a time in which the disputed claim was made, a topic to which the disputed claim relates, or any other information relevant to the disputed claim. In some examples, claims information 123 may also include facts presented by the disputing entities to dispute the disputed claim (e.g., the other sequence of occurrences per the above example).

If disputed claims service 101 continues to receive content items 122 from content item repository 102 (e.g., as new articles are posted), disputed claims service 101 may continue to identify new disputed claims and/or augment information for disputed claims already identified (e.g., if another entity is determined to support the disputed claim, then disputed claims service 101 may add that entity to the supporting entities in claims information 123).

Disputed claims service 101 receives analysis parameters 125 from user 131 (204). Analysis parameters 125 define what portions of claims information 123 user 131 desires. Analysis parameters 125 may be formatted as a Boolean search query. Disputed claims service 101 searches claims information 123 based on the parameters to identify portions of claims information 123 that satisfy analysis parameters 125. For example, analysis parameters 125 may request all disputed claims surrounding a particular event, all disputed claims during a particular time period and related to a particular geographic location, all disputed claims made by a particular entity, or some other parameters for filtering what portions of claims information 123 user 131 wishes to see.

In response to receiving analysis parameters 125, disputed claims service 101 presents claim information 124 to user 131 (205). Claim information 124 is a portion of claims information 123 that disputed claims service 101 identifies as satisfying analysis parameters 125. Claim information 124 may be displayed to user 131, provided as a file to user 131, or supplied to user 131 in some other manner. In some examples, user 131 may further adjust analysis parameters 125 to hone what portions of claims information 123 user 131 receives in claim information 124. For instance, upon viewing claim information 124, user 131 may determine that a particular disputing entity is of interest. User 131 may then adjust analysis parameters 125 to request claims disputed by the disputing entity and disputed claims service 101 provides updated claim information 124 accordingly.

While the above operation may imply that claims in general have to be identified before disputed claims can be identified therefrom, in some examples, content items having disputed claims may be identified before identifying the actual disputed claims therein. Those examples are likely able to conserve processing resources that would have been used to identify claims that are not disputed. The raw information (e.g., text) in a content item is used by disputed claims service 101 to determine that the content item includes disputed information (e.g., keywords, phrases, etc. may be used to indicate whether a content item included disputed information). The claims being disputed are then identified from within the content items that disputed claims service 101 has determined to include disputed information.

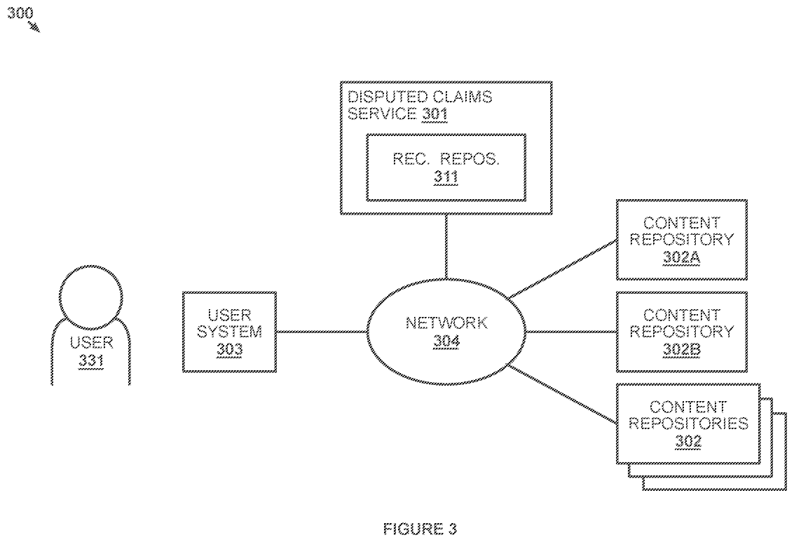

FIG. 3 illustrates implementation 300 for identifying disputed claims in electronic content items. Implementation 300 includes disputed claims service 301, content repositories 302, user system 303, and communication network 304. Disputed claims service 301, content repositories 302, and user system 303 exchange communications over communication network 304, which may include one or more local and/or wide area computing networks, including the Internet. User system 303 is a computing system of user 331. User 331 operates user system 303 to access the services of disputed claims service 301. User system 303 may be a personal computer, tablet computer, smartphone, electronic advertising display, information kiosk, or some other type of user-operable computing system.

In this example, disputed claims service 301 is implemented by one or more computing systems that process content items from content repositories 302 and identify disputed claims therein to present information about those disputed claims to user 331 via user system 303. Disputed claims service 301 includes record repository 311, which includes computer readable storage media, for storing disputed claims records created as described below. The content items may include news articles, blog posts, social media posts, videos, audio, podcasts, or some other type of media that conveys information to a user—including combinations thereof. Content repositories 302 may include web servers, media servers, file servers, podcast servers, or some other type of computing system that provides content items over a communication network—including combinations thereof. Disputed claims service 301 may retrieve content items from content repositories 302 in the same manner that a user system, like user system 303, would retrieve the content items. For example, content repository 302A and content repository 302B are specific examples of repositories in content repositories 302. If content repository 302A is a web server, then disputed claims service 301 may request a webpage having a news article (or other type of media that can be included on a webpage) from the web server using the same protocols as a web browser on user system 303 would use to request that same web page. In another example, content repository 302B may be a podcast server and disputed claims service 301 may retrieve a podcast episode using the same protocols as a podcast application executing on user system 303 would retrieve that same podcast.

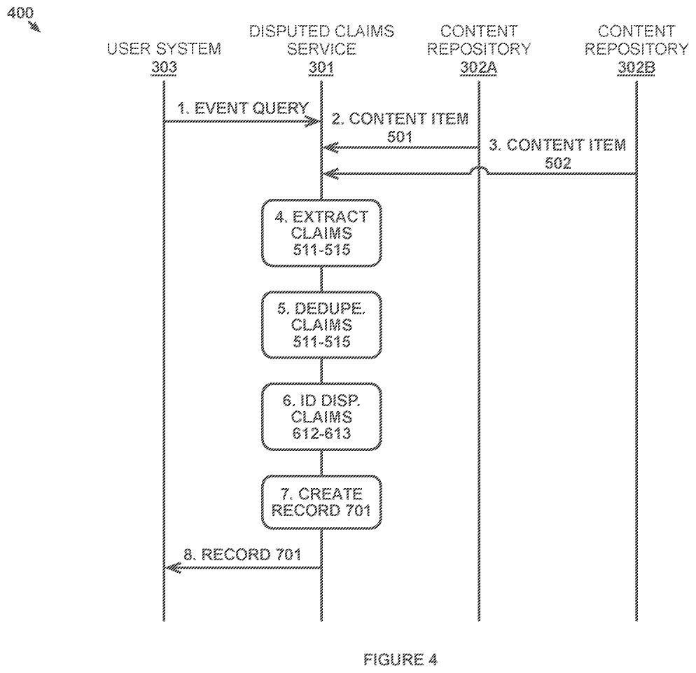

FIG. 4 illustrates operational scenario 400 for identifying disputed claims in electronic content items. In operational scenario 400, user 331 is interested in whether there are disputed claims regarding a particular event. The event in this scenario is a fire at a building. User 331 enters a search query describing the event into user system 303. For instance, the search query may be a Boolean query that indicates parameters such as the name of the store, the location of the store, a date of the fire, and/or any other information that disputed claims service 301 may use to identify content items pertaining to the event. The query is transmitted to disputed claims service 301 at step 1. In some examples, disputed claims service 301 may provide a website to which user 331 navigates a web browser of user system 303. The query may be entered into the website to supply disputed claims service 301 with the query. In other examples, a client application for interfacing with disputed claims service 301 may execute on user system 303 to receive the query from user 331 and transmit the query to disputed claims service 301.

In response to receiving the query, disputed claims service 301 retrieves content items concerning (e.g., mentioning, describing, discussing, etc.) the event identified by the query. Specifically, disputed claims service 301 retrieves content item 501 from content repository 302A at step 2 and content item 502 from content repository 302B at step 3. Disputed claims service 301 may retrieve further content items from others of content repositories 302 (or additional content items from content repository 302A and content repository 302B) in other examples. In some examples, disputed claims service 301 may index content items in content repositories 302 and searches the index to identify content items using the parameters in the query. In some examples, disputed claims service 301 may employ a third-party search engine to find content items that satisfy the query. Disputed claims service 301 may also employ search functions supplied by one or more of content repositories 302 to search content items provided thereby (e.g., a website will often include a search feature where a user can search for pages/content within the site).

Disputed claims service 301 passes content item 501 and content item 502 through a Natural Language Processing (NLP) algorithm at step 4 to extract claims from content item 501 and content item 502. The NLP algorithm may be a machine learning algorithm that is trained to identify claims being made within content items and identify an entity, or entities, making that claim. A claim is an assertion or statement of fact being made by an entity. The entity may be a person, business, government, or some other type of organization. In some examples, the NPL algorithm may recognize that a claim should be attributed to another entity rather than the person making the claim (e.g., may recognize that a spokesperson for a different person or business is making a claim on that other person/business' behalf).

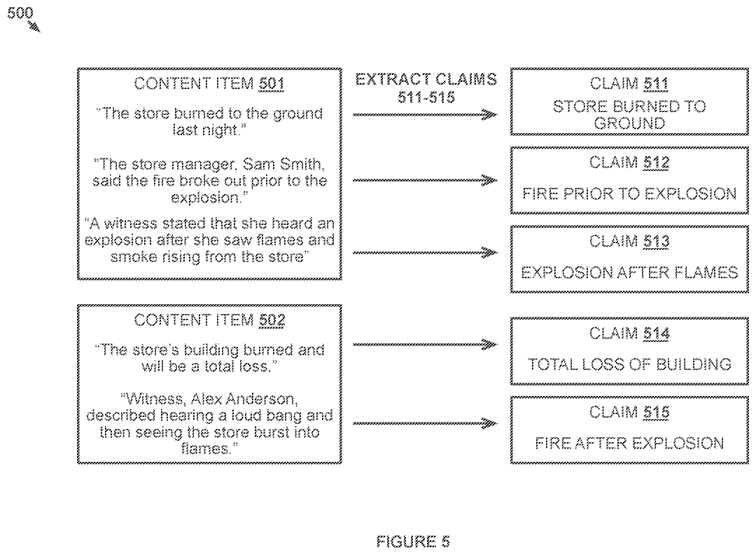

FIG. 5 illustrates operational scenario 500 for identifying disputed claims in electronic content items. Operational scenario 500 is a more detailed example of step 4 in operational scenario 400. Disputed claims service 301 identifies three passages from within content item 501 and two passages within content item 502 as being claims. The three claims from content item 501 are claims 511-513 and the two claims from content item 502 are claims 514-515. Rather than using the quoted language verbatim from content item 501 and content item 502, disputed claims service 301 simplifies the assertions being made therein. An NPL algorithm may be used to generate the simplified ideas from the quoted language or disputed claims service 301 may use rules to extract parts of speech to generate the simplified claims 511-515. In some examples, disputed claims service 301 may tokenize portions of the quoted language to

Referring back to operational scenario 400, after extracting claims 511-515, disputed claims service 301 identifies duplicate claims and consolidates the claims into a single claim at step 5. Operational scenario 600 below continues from operational scenario 500 to provide a more detailed example of disputed claims service 301 performing step 5.

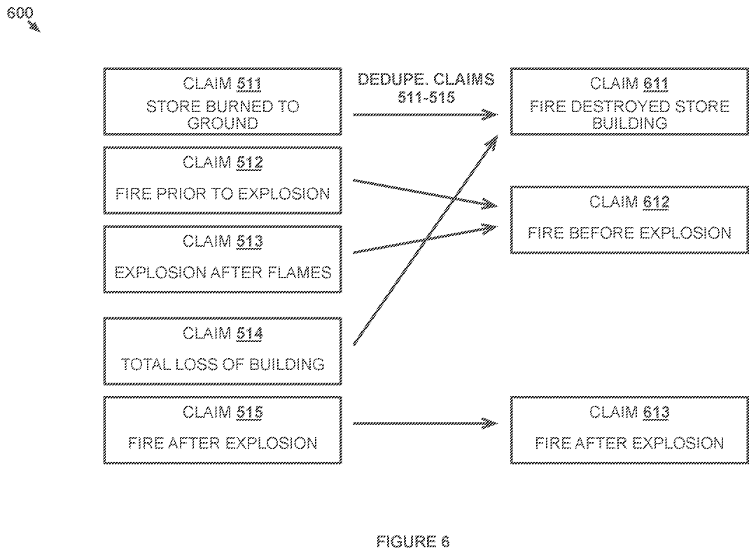

FIG. 6 illustrates operational scenario 600 for identifying disputed claims in electronic content items. In operational scenario 600, disputed claims service 301 recognizes that claim 511 and claim 514 are making the same claim. In this case, rather than using the simplified wording of either claim, disputed claims service 301 generates claim 611 by creating a phrase that captures the fact(s) asserted by claim 511 and claim 514. Specifically, disputed claims service 301 determines that claim 511 and claim 514 are expressing that fire destroyed the building of the store and creates claim 611 accordingly. Disputed claims service 301 also determines that claim 512 and claim 513 are expressing the same idea and generates claim 612 accordingly. Claim 515 is not the same as any other claim in operational scenario 600 and, therefore, disputed claims service 301 generates claim 613 as a direct copy of claim 515. Although, in other examples, disputed claims service 301 may reword claim 613 (e.g., to use phrasing similar to that already used for other claims). Even though disputed claims service 301 consolidated duplicate claims into a single claim, disputed claims service 301 may still maintain the originally extracted claim and/or original language captured from content item 501 and content item 502. For example, the original language may be important to user 331 and disputed claims service 301 may provide that original claim/language upon request.

Again, referring back to operational scenario 400, disputed claims service 301 identifies disputed claims from claims 611-613 at step 6. In some cases, disputed claims service 301 may look for claims that use overt language to dispute another claim (e.g., Party B asserts Party A's account of the event is incorrect). In other cases, which are often harder to recognize, especially across content items, disputed claims service 301 may recognize that the facts being asserted by one claim differ from those being asserted by another. The present example includes two disputed claims. Claim 612 is disputed by claim 613, and vice versa. Claim 612 and claim 613 indicate a different order of the fire and the explosion. In response to identifying a disputed claim, disputed claims service 301 creates disputed claim record 701 at step 7, which is detailed below in operational scenario 700, and stores disputed claim record 701 in record repository 311.

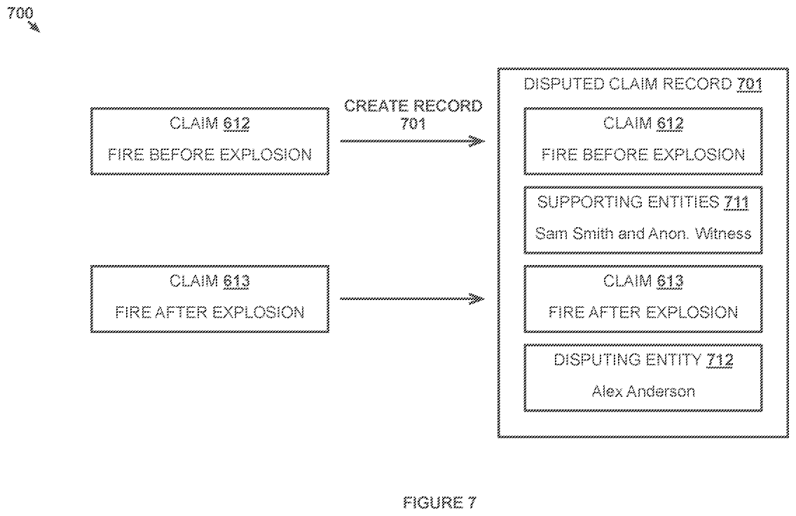

FIG. 7 illustrates an operational scenario 700 for identifying disputed claims in electronic content items. Disputed claims service 301 includes claim 612 in disputed claim record 701 and indicates supporting entities 711 therein. In this case, supporting entities 711 are Sam Smith and an anonymous (or at least unidentified) witness. Disputed claims service 301 further includes claim 613 to provide the disputing facts. In some examples, disputing facts may not exist, as the disputing claim may simply state that the disputed claim is wrong. Disputed claims service 301 may not include the disputing claim in those examples. Disputed claims service 301 also includes disputing entity 712 in disputed claim record 701. Disputing entity 712 is Alex Anderson according to the quote from content item 502.

In some examples, a separate record may be created for claim 613 being the disputed claim while claim 612 is the disputing claim. Supporting entities 711 and disputing entity 712 would be swapped in that record as well. However, disputed claims service 301 may be configured to use the information in disputed claim record 701 regardless of whether claim 612 or claim 613 is considered the disputed claim. Furthermore, disputed claims service 301 may update disputed claim record 701 with additional supporting or disputing entities as more content items are retrieved. For instance, an article may be late to publish and disputed claims service 301 may retrieve the article after disputed claim record 701 has already been created (i.e., may iteratively update the content items captured by the search query). Disputed claims service 301 may generate a claim from the article and determine that the claim is the same as claim 13 (i.e., is consolidated into claim 13 per step 5). In those examples, should the claim be made by a new disputing entity, then disputed claims service 301 will add the new entity to disputing entity 712.

In some examples, disputed claim record 701 may include additional information not shown. For instance, disputed claims service 301 may indicate the sources (e.g., content repositories and/or specific content items) from which each claim was obtained, may indicate an author of the content item, especially if different from the entity to which the claim is attributed, or may indicate some other information about the claims that may be relevant to user 331.

Referring back to operational scenario 400 once again, disputed claims service 301 returns disputed claim record 701 to user system 303 at step 8 in response to the received query. User system 303 may then present the information in disputed claim record 701 to user 331 for consumption. Disputed claim record 701 may be provided in its original file format stored in record repository 311 or disputed claims service 301 may provide the information in the record (e.g., may present the information in a webpage). In some examples, disputed claims service 301 may create/store in record repository 311 additional records for additional disputed claims that were identified. In those examples, disputed claims service 301 may return those records as well in response to the query. Disputed claims service 301 may further aggregate information, including statistical information, records maintained therein that may be relevant to user 331, including disputed claim records regarding other events (e.g., disputed claims identified in response to other queries or automatically identified by disputed claims service 301 in preparation for queries being received). For example, a disputing entity may have a history of disputing claims (e.g., claims in general, claims regarding a particular topic, claims made by a particular supporting entity, etc.). Disputed claims service 301 may recognize that fact and present the information to user 331 or user 331 may request disputed claims service 301 to provide them with additional claims that the disputing entity has disputed. In other words, disputed claims service 301 may provide many different combinations of the information stored in record repository 311, not just information about disputed claims regarding a particular event. For example, user 331 may pose a query via user system 303 requesting information about claims made by a particular entity or claims included in a particular source for a defined time range. In response to that query, disputed claims service 301 may search disputed claim records in record repository 311 and present information about the results of the search. The information may include the records referenced during the search, statistics about what disputed claims service 301 found (e.g., X number of disputed claims were made by the entity), or some other information relevant to the search query.

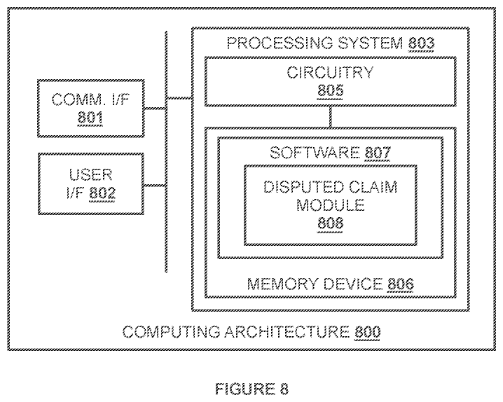

FIG. 8 illustrates computing architecture 800 for identifying disputed claims in electronic content items. Computing architecture 800 is representative of any computing system or systems with which the various operational architectures, processes, scenarios, and sequences disclosed herein for a disputed claims service may be implemented. Computing architecture 800 is an example of computer systems implementing disputed claims service 101, although other examples may exist. Computing architecture 800 comprises communication interface 801, user interface 802, and processing system 803. Processing system 803 is linked to communication interface 801 and user interface 802. Processing system 803 includes processing circuitry 805 and memory device 806 that stores operating software 807. Computing architecture 800 may include other well-known components such as a battery and enclosure that are not shown for clarity.

Communication interface 801 comprises components that communicate over communication links, such as network cards, ports, radio frequency (RF), processing circuitry and software, or some other communication devices. Communication interface 801 may be configured to communicate over metallic, wireless, or optical links. Communication interface 801 may be configured to use Time Division Multiplex (TDM), Internet Protocol (IP), Ethernet, optical networking, wireless protocols, communication signaling, or some other communication format—including combinations thereof. In some implementations, communication interface 801 may be configured to communicate with information and supplemental resources to obtain objects for defining events. Communication interface 801 may further be configured to communicate with client or console devices of end users, wherein the users may request and receive disputed claim information from the disputed claims service.

User interface 802 comprises components that interact with a user to receive user inputs and to present media and/or information. User interface 802 may include a speaker, microphone, buttons, lights, display screen, touch screen, touch pad, scroll wheel, communication port, or some other user input/output apparatus—including combinations thereof. User interface 802 may be omitted in some examples.

Processing circuitry 805 comprises microprocessor and other circuitry that retrieves and executes operating software 807 from memory device 806. Memory device 806 comprises a computer readable storage medium, such as a disk drive, flash drive, data storage circuitry, or some other memory apparatus. In no examples would a computer readable storage medium of memory device 806, or any other computer readable storage medium herein, be considered a transitory form of signal transmission (often referred to as “signals per se”), such as a propagating electrical or electromagnetic signal or carrier wave. Operating software 807 comprises computer programs, firmware, or some other form of machine-readable processing instructions. Operating software 807 includes disputed claim module 808. Operating software 807 may further include an operating system, utilities, drivers, network interfaces, applications, or some other type of software. When executed by processing circuitry 805, operating software 807 directs processing system 803 to operate computing architecture 800 as described herein.

In one implementation, disputed claim module 808 directs processing system 803 to extract first claims from language in a set of electronic content items and determine that a disputed claim of the first claims is disputed by one or more disputing entities. Disputed claim module 808 further directs processing system 803 to store claim information about the disputed claim in a repository. The claim information indicates the disputed claim, one or more supporting entities that support the disputed claim, and the disputing identities. Disputed claim module 808 also directs processing system 803 to receive analysis parameters from a user, wherein the claim information satisfies the analysis parameters. In response to receiving the analysis parameters, disputed claim module 808 directs processing system 803 to present at least a portion of the claim information to the user.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method comprising:
in a computing system implementing a disputed claims service:
extracting first claims from language in a set of electronic content items;
determining that a disputed claim of the first claims is disputed by one or more disputing entities;
storing claim information about the disputed claim in a repository, wherein the claim information indicates the disputed claim, one or more supporting entities that support the disputed claim, and the disputing entities;
receiving analysis parameters from a user, wherein the claim information satisfies the analysis parameters; and
in response to receiving the analysis parameters, presenting at least a portion of the claim information to the user.

2. The method of claim 1, comprising:
retrieving the set of electronic content items over a communication network from one or more content item repositories.

3. The method of claim 1, comprising:
iteratively retrieving a first portion of the set of electronic content items that are new since a previous retrieval of a second portion of the set of electronic content items.

4. The method of claim 1, comprising:
in response to identifying a first instance of the disputed claim in a first content item, creating a record for the disputed claim in the repository, wherein the record includes the claim information; and
in response to identifying a second instance of the disputed claim in a second content time, updating the record based on the second instance.

5. The method of claim 4, wherein the second instance phrases the disputed claim differently than the first instance.

6. The method of claim 1, wherein extracting the first claims comprises:
passing the set of electronic content items through a Natural Language Processing (NLP) algorithm trained to recognize language used when making a claim.

7. The method of claim 1, wherein determining that a disputed claim of the first claims is disputed by one or more disputing entities comprises:
determining that facts about an event in the disputed claim differ from facts about the event in one or more other claims of the first claims.

8. The method of claim 1, wherein the analysis parameters comprise a Boolean search query.

9. The method of claim 1, wherein the set of electronic content items includes one or more of media types including news articles, blog posts, social media posts, videos, and podcasts.

10. The method of claim 1, wherein the computing system comprises a user device of the user.

11. An apparatus comprising:
one or more computer readable storage media;
a processing system operatively coupled with the one or more computer readable storage media; and
program instructions stored on the one or more computer readable storage media that, when read and executed by the processing system, direct the apparatus to:
extract first claims from language in a set of electronic content items;
determine that a disputed claim of the first claims is disputed by one or more disputing entities;
store claim information about the disputed claim in a repository, wherein the claim information indicates the disputed claim, one or more supporting entities that support the disputed claim, and the disputing entities;
receive analysis parameters from a user, wherein the claim information satisfies the analysis parameters; and
in response to receiving the analysis parameters, present at least a portion of the claim information to the user.

12. The apparatus of claim 11, wherein the program instructions direct the apparatus to:
retrieve the set of electronic content items over a communication network from one or more content item repositories.

13. The apparatus of claim 11, wherein the program instructions direct the apparatus to:
iteratively retrieve a first portion of the set of electronic content items that are new since a previous retrieval of a second portion of the set of electronic content items.

14. The apparatus of claim 11, wherein the program instructions direct the apparatus to:
in response to identifying a first instance of the disputed claim in a first content item, create a record for the disputed claim in the repository, wherein the record includes the claim information; and
in response to identifying a second instance of the disputed claim in a second content time, update the record based on the second instance.

15. The apparatus of claim 14, wherein the second instance phrases the disputed claim differently than the first instance.

16. The apparatus of claim 11, wherein to extract the first claims, the program instructions direct the apparatus to:
pass the set of electronic content items through a Natural Language Processing (NLP) algorithm trained to recognize language used when making a claim.

17. The apparatus of claim 11, wherein to determine that a disputed claim of the first claims is disputed by one or more disputing entities, the program instructions direct the apparatus to:
determine that facts about an event in the disputed claim differ from facts about the event in one or more other claims of the first claims.

18. The apparatus of claim 11, wherein the analysis parameters comprise a Boolean search query.

19. The apparatus of claim 11, wherein the set of electronic content items includes one or more of media types including news articles, blog posts, social media posts, videos, and podcasts.

20. One or more computer readable storage media having program instructions stored thereon that, when read and executed by a processing system, direct the processing system to:
extract first claims from language in a set of electronic content items;
determine that a disputed claim of the first claims is disputed by one or more disputing entities;
store claim information about the disputed claim in a repository, wherein the claim information indicates the disputed claim, one or more supporting entities that support the disputed claim, and the disputing entities;
receive analysis parameters from a user, wherein the claim information satisfies the analysis parameters; and
in response to receiving the analysis parameters, present at least a portion of the claim information to the user.
